(19) United States
(12) Patent Application Publication
(10) Pub. No.: US 2023/0350184 A1
(43) Pub. Date: Nov. 2, 2023

(54) MOBILE IMAGING SYSTEM

(71) Applicant: Analytik Jena US LLC, Upland, CA (US)

(72) Inventors: Sean Gallagher, Claremont, CA (US); Darius Kelly, Rancho Cucamonga, CA (US)

(21) Appl. No.: 18/308,186

(22) Filed: Apr. 27, 2023

Related U.S. Application Data
(60) Provisional application No. 63/335,806, filed on Apr. 28, 2022.

(51) Int. Cl. G02B 21/36; H04N 23/62; G06T 7/00; G02B 21/00

(52) U.S. Cl. CPC G02B 21/362; H04N 23/62; G06T 7/0012; G02B 21/0008; G06T 2200/24

(57) ABSTRACT

A mobile imaging system includes an imaging box, including an enclosure for blocking an interior of the imaging box from ambient light, where the imaging box includes an opening through the enclosure. A designated surface is positioned within the interior of the imaging box for supporting a sample, where the sample, when supported on the designated surface, is viewable through the opening. The imaging box includes an energy source for transmitting light through the sample. A support structure is fixedly attached to an exterior of the imaging box at the opening for releasably attaching a mobile device to the imaging box over the opening. When the mobile device is releasably attached to the imaging box, the support structure is configured to face a camera lens of the mobile device toward the sample.

### CROSS-REFERENCE TO RELATED APPLICATION

The present application is related to and claims the priority benefit of U.S. Provisional Patent Application No. 63/335,806, filed on Apr. 28, 2022, the entire contents of which are incorporated herein by reference.

### TECHNICAL FIELD

The present disclosure relates to imaging and documentation systems for analyzing results of gel electrophoresis and membrane blotting experiments.

### BACKGROUND

Gel documentation, or gel imaging, systems are used to record and measure labeled nucleic acid and protein in a variety of configurations depending on throughput and sample type. Imaging systems, such as gel imaging systems, with all the necessary components, are too complex and expensive for the average educational institution or personal consumer.

### SUMMARY

The present disclosure relates to imaging systems, which include mobile devices and cloud-based connectivity platforms.

### BRIEF DESCRIPTION OF THE DRAWINGS

FIG. 1 depicts a block diagram of an exemplary embodiment of an imaging system, according to the present disclosure.

FIG. 2 depicts an exemplary imaging box configured to support a mobile device, according to the present disclosure.

FIG. 3 depicts a section view of the imaging box of the present disclosure.

FIG. 4 depicts a top view of an exemplary support structure for the mobile device, according to the present disclosure.

FIG. 5 depicts a side view of the exemplary support structure of FIG. 4, according to the present disclosure.

FIG. 6 depicts an exemplary home screen of a graphical user interface of the mobile device, according to the present disclosure.

FIG. 7 depicts an exemplary main interface screen of the graphical user interface for selecting imaging techniques, according to the present disclosure.

FIG. 8 depicts an exemplary screen of the graphical user interface displaying results of an exemplary 1-D analysis, with automated lanes and bands detection after capture of an image, according to the present disclosure.

FIG. 9 depicts an exemplary screen of the graphical user interface displaying results of an exemplary 1-D analysis, with a change in the drawn lane color for greater contrast, according to the present disclosure.

FIG. 10 depicts an exemplary screen of the graphical user interface displaying results of an exemplary 1-D analysis, with an adjustment to lane and band position, size and number, according to the present disclosure.

FIG. 11 depicts an exemplary screen of the graphical user interface for viewing a report generated from the 1-D analysis, according to the present disclosure.

FIG. 12 depicts an exemplary screen of the graphical user interface illustrating an option of emailing a copy of a generated report, according to the present disclosure.

FIG. 13 depicts an exemplary screen of the graphical user interface illustrating results of a densitometry analysis for analyzing bands by density instead of as part of a lane, according to the present disclosure.

FIG. 14 depicts an exemplary screen of the graphical user interface illustrating a colony count, categorizing colonies by classes, according to the present disclosure.

FIG. 15 depicts an exemplary screen of the graphical user interface illustrating a colony count, with automated colony detection, according to the present disclosure.

FIG. 16 depicts an exemplary screen of the graphical user interface illustrating a colony count, filtering colonies by size and circularity, according to the present disclosure.

FIG. 17 depicts an exemplary screen of the graphical user interface illustrating a report generated from the colony count.

### SUMMARY

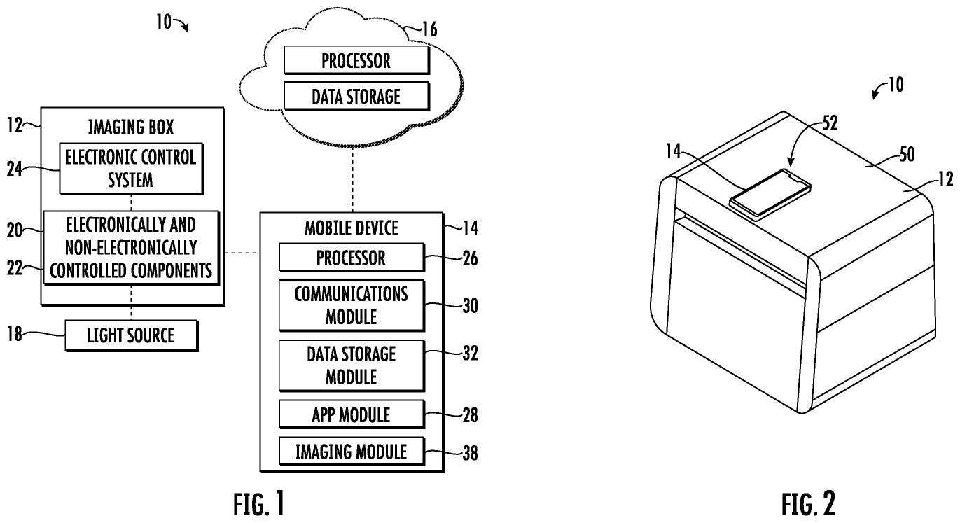

Depicted in FIG. 1 is a block diagram of an imaging system 10, according to the present disclosure, which includes an imaging box 12, a mobile device 14, and cloud-based services 16. According to an exemplary embodiment, the imaging system 10 may be configured for gel documentation, or gel imaging, and may be used, for example, to record and measure labeled nucleic acid and protein in various types of media such as agarose, acrylamide, or cellulose.

The imaging system 10 may include or use a plurality of different components, such as a light source 18 positioned within the imaging box 12. The imaging box 12, according to the exemplary embodiment, may be described generally as an enclosure for shielding an interior of the imaging box 12, and samples positioned in the imaging box 12, from external light sources, including ambient light, and providing a darkroom environment. The imaging box 12 includes an opening therethrough for viewing samples positioned on or at a designated surface positioned within the interior of the imaging box 12.

Further, the imaging box 12, as will be described below, may include a plurality of electronically controlled components 20 and non-electronically controlled components 22. An electronic control system 24, included in or in communication with the imaging box 12, may be configured to control some features or parameters of the imaging box 12, such as, positions of filters and/or lenses, and/or other electronically controlled components 20 of the imaging box 12. For example, the electronic control system 24 may control operation of a motor configured to change or reposition filters and/or lenses. One of the electronically controlled components 20 of the imaging box 12 may be a controller for an environmental condition inside the imaging box 12.

The mobile device 14 may include one or more hardware processors, or central processing units, 26 for executing one or more programs and controlling operations of one or more components 20, 22, consistent with the teachings herein. A mobile app, part of the app, or application, module 28, is configured for installation on the mobile device 14 and is configured to communicatively connect the mobile device 14 and the imaging box electronic control system 24. The mobile app is configured for user interaction via a graphical user interface of the mobile device 14. The graphical user interface facilitates control of camera features of the mobile device 14 including at least one of a light, filter, and lens.

The mobile device 14 also includes a communications module 30, which facilitates communications between components within and/or outside the mobile device 14. The components of the mobile device 14, and even the imaging system 10 in general, may include or utilize multiple interacting computing systems or devices and may be connected to other devices that are not specifically illustrated, including via Bluetooth communication or other direct communication, through one or more networks such as the Internet, via the Web, or via one or more private networks (e.g., mobile communication networks, etc.).

A device or other component of the imaging system 10 of the present disclosure may comprise any combination of hardware and/or software that may interact and perform the functionality described herein. Exemplary hardware may include, without limitation, desktop computers or other computers (e.g., tablets, slates, etc.), database servers, network storage devices and other network devices, smart phones and other mobile phones and devices.

The data storage module 32 may include memory for storing data and images, and instructions for the mobile device 14 that are processed by the one or more processors 26.

The app module 28 may utilize and/or interact with the processor 26, communications module 30, and/or data storage module 32 for facilitating the operations of the imaging system 10 of the present disclosure. The app module 28 may include and/or utilize imaging and/or analysis software related to the functionality of the present disclosure. Specifically, the app module 28 may include analysis functionality for analyzing the sample based on the photos. Alternatively, or additionally, the analysis software, referenced also as computer readable medium, may reside in the cloud 16, and utilize cloud-based services, including processors 34 and storage 36.

The imaging module 38 may include one or more imaging components, which include photographic and/or video recording capabilities (optionally with one or more specialized lenses and/or filters and/or additional associated equipment). The mobile device 14 is configured for capturing photos using a camera of the mobile device 14.

The app module 28 and/or the imaging module 38 may facilitate the manual or automatic capture of images with the mobile device 14, according to the present disclosure.

The mobile device 14 also includes a display system, which includes a main display screen having a plurality of graphical display elements that facilitate user input for operating the imaging system 10, as discussed later in greater detail.

Cloud-based networking is referred to as the network communication and interconnectivity between IT resources/application within a cloud computing infrastructure. It may include one or more processors 34, on servers, and data storage 36 and enables a cloud computing solution/service to interact and perform network connection with other resources on the cloud 16. Any cloud-based solution refers to applications, storage, on-demand services, computer networks, or other resources that are accessed with an internet connection through another provider's shared cloud computing framework.

Turning now to FIG. 2, the exemplary imaging box 12 may include an enclosure 50, or housing, that blocks light from entering the imaging box 12. The imaging box 12 should be suitable for performing photography procedures, such as photographing gels. The imaging box 12 also includes a support region 52 for a mobile device 14. The mobile device 14 may be any suitable electronic device, such as a smart phone, smart tablet, or other, and may support operating systems, such as, for example, iOS and Android.

Additional exemplary components of the imaging box 12 are shown in FIG. 3. The imaging box 12 includes the enclosure 50, or housing, that facilitates transmission of an energy source (e.g., UV or visible light) 18 through a sample 60. For example, imaging box 12 may also include an illuminator, such as a transilluminator, providing the light for use in various procedures. Additionally, or alternatively, the energy source 18 may include epi-illumination, which involves reflecting the energy source (e.g., UV or visible light) 18 off the sample 60 to generate contrast (absorption) for visible light applications.

An emission filter wheel 62, may include a plurality of emission filters (proper filter wavelengths) that are rotatable with the emission filter wheel 62 such that each filter may be positioned in a camera field of view of the sample 54 in series with rotation of the emission filter wheel 62. Filter wheels 62 are used on microscopes, cameras, and video systems to position a selected filter in an imaging path quickly and accurately. Typically, a filter, or combination of filters, is used to attenuate the light intensity, or to prevent unwanted spectral wavelengths from contaminating the recorded, or captured, image.

The mobile device 14 may operate according to the app module 28 and may be used to facilitate manual capture/auto capture, stack capture and/or series capture of images of the sample 60, when the sample 60 is positioned at a designated surface 64. Further, the mobile device 14 may be configured to provide a one-dimensional analysis, including: lanes and bands detection; molecular weight calibration; concentration calibration; and addition and deletion of colonies, size, and circularity filter. The mobile device 14 may communicate with the cloud-based system 16, providing storage and analysis of captured images.

Camera adjustment features of the imaging system 10 may include the ability to edit images (e.g., flip horizontally and vertically, rotate, crop, view as black and white, remove noise, enhance and sharpen.) Annotation tools, including text, highlighting, date/time stamping may also be available, along with the ability to determine area density (densitometry analysis), add/delete regions of interest, and colony counting.

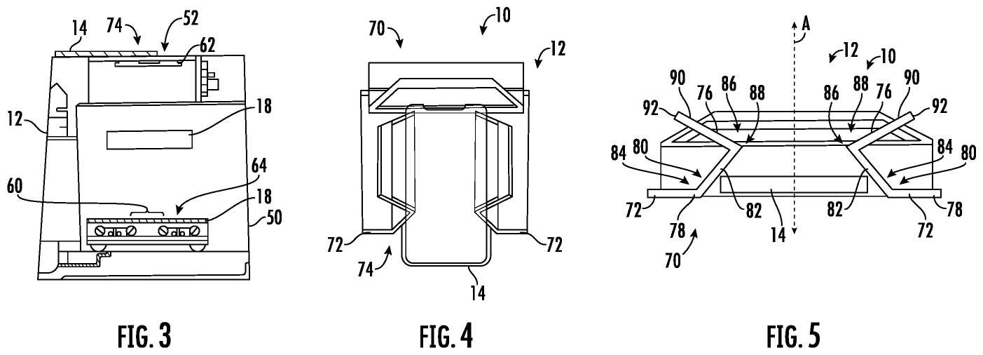

FIG. 4 is a top view of a support structure 70 for the mobile device 14 and FIG. 5 is a side view of the support structure 70 for the mobile device 14. The support structure 70 is used for positioning, supporting, and securing the mobile device 14 relative to the imaging box 12. According to the exemplary embodiment, the mobile device 14 is positioned such that a line of sight passing through the mobile device camera also passes through the appropriate lenses and filters and toward the sample 60. Further, the support structure 70 should maintain the phone position, block out ambient light, and fit different mobile devices 14. When the mobile device 14 is releasably attached to the imaging box 12, the support structure 70 is configured to direct or face a camera lens of the mobile device 12 toward the sample 60.

According to the exemplary embodiment, the support structure 70 includes a pair of fold latch mechanisms 72 positioned on opposing sides of the opening of the imaging box 12. Each of the pair of fold latch mechanisms 72 biases the mobile device 14 toward the imaging box 12 and a released configuration in which the fold latch mechanism 72 is urged against the bias away from the mobile device 14.

Referring also to FIG. 5, and according to the exemplary embodiment, the support structure 70 includes one or more folded pieces of material 76. A first portion 78 of each folded piece of material 76 has a fixed position relative to the imaging box 12. One edge 80 of the first portion 78 transitions to a second portion 82 at a first flexible, hinged joint 84. The second portion 82 of each folded piece 76 has a second flexible hinged joint 86 defined at an edge 88 of the second portion 82 opposite the first flexible hinged joint 84, with the second flexible hinged joint 86 extending above at least a portion of the mobile device 14 relative to a vertical axis A, and the second portion 82 being biased toward the mobile device 14 at the first flexible hinged joint 84, when a mobile device 14 is secured at a predetermined position relative to the imaging box 12. The second portion 82 transitions to a third portion 90 at the second flexible hinged joint 86, with the third portion 90 having a free edge 92 opposite the second flexible hinged joint 86. The third portion 90, and the free edge 92 thereof, may be used to urge the second portion 82 outward, against the bias of the first flexible hinged joint 84 and the second flexible hinged joint 86, to remove the mobile device 14 from the predetermined position.

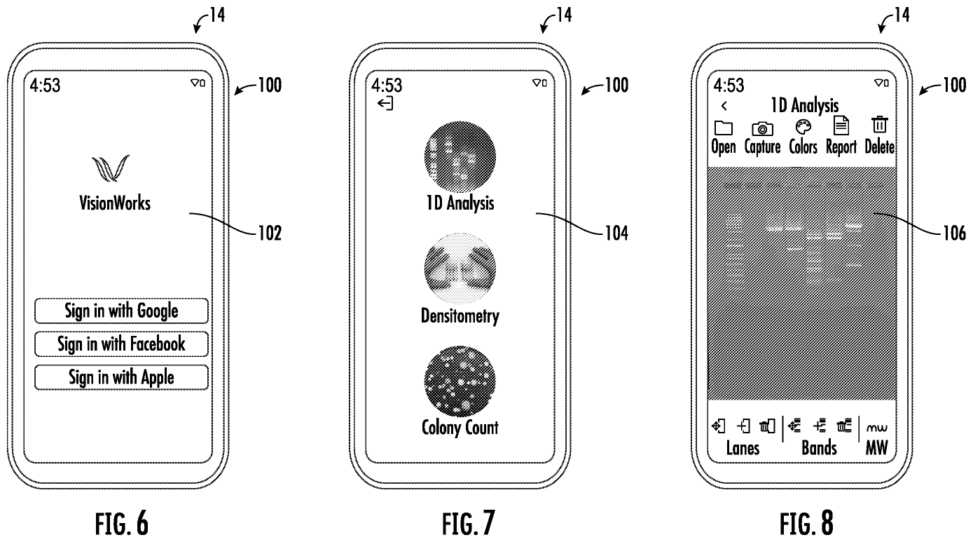

FIG. 6 depicts an exemplary graphical user interface 100 of a mobile device 14. In particular, the mobile device 14 of FIG. 6 may display a home screen 102 for a particular application of the present disclosure. FIG. 7 depicts an exemplary main interface screen 104 of the graphical user interface 100 for selecting imaging techniques, according to the present disclosure. For example, the user may select between protein gels for protein analysis, nucleic acid gels for separating DNA or RNA fragments by size and reactivity, western blotting for detecting a specific protein in a blood or tissue sample, and colony count for counts of organisms grown as colonies on or in nutrient agar, providing a useful means of assessing the general bacterial content of a water.

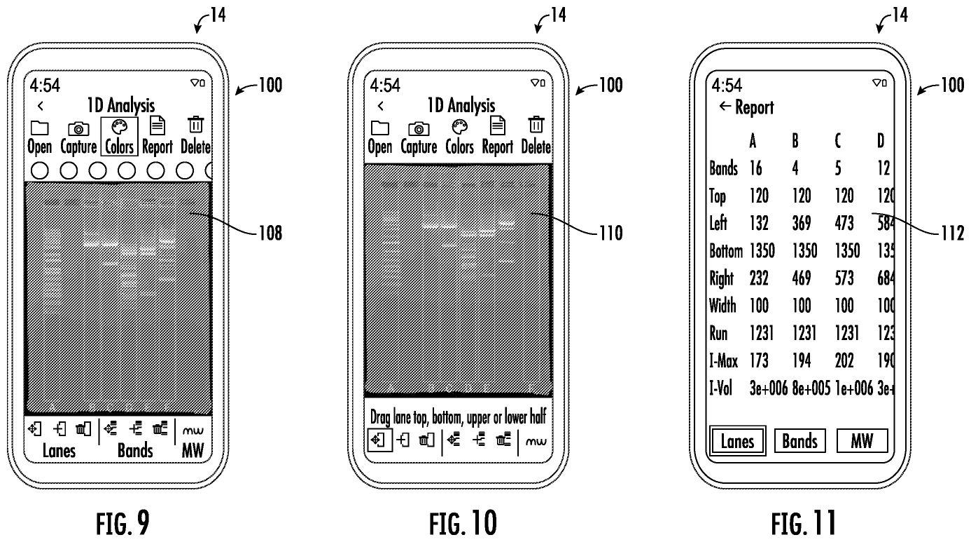

FIG. 8 depicts an exemplary screen 106 of the graphical user interface 100 displaying an exemplary 1-D analysis, with automated lanes and bands detection after capture of an image, according to the present disclosure. FIG. 9 depicts an exemplary screen 108 of the graphical user interface displaying an exemplary 1-D analysis, with a change in the drawn lane color for greater contrast, according to the present disclosure. FIG. 10 depicts an exemplary screen 110 of the graphical user interface displaying an exemplary 1-D analysis, with an adjustment to lane and band position, size and number, according to the present disclosure.

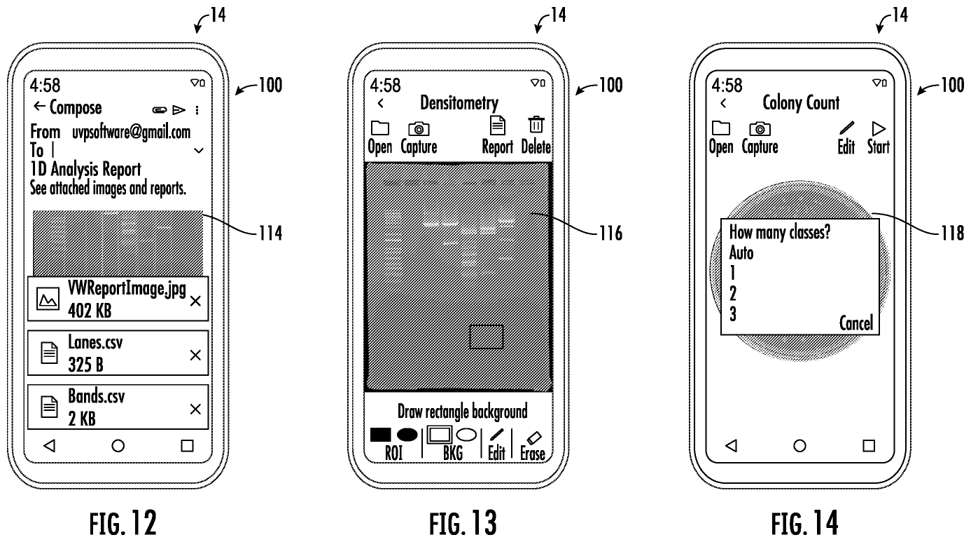

FIG. 11 depicts an exemplary screen 112 of the graphical user interface 100 for viewing a report generated from the 1-D analysis, according to the present disclosure. FIG. 12 depicts an exemplary screen 114 of the graphical user interface 100 illustrating an option of emailing a copy of a generated report, according to the present disclosure.

FIG. 13 depicts an exemplary screen 116 of the graphical user interface 100 illustrating a densitometry analysis for analyzing bands by density instead of as part of a lane, according to the present disclosure.

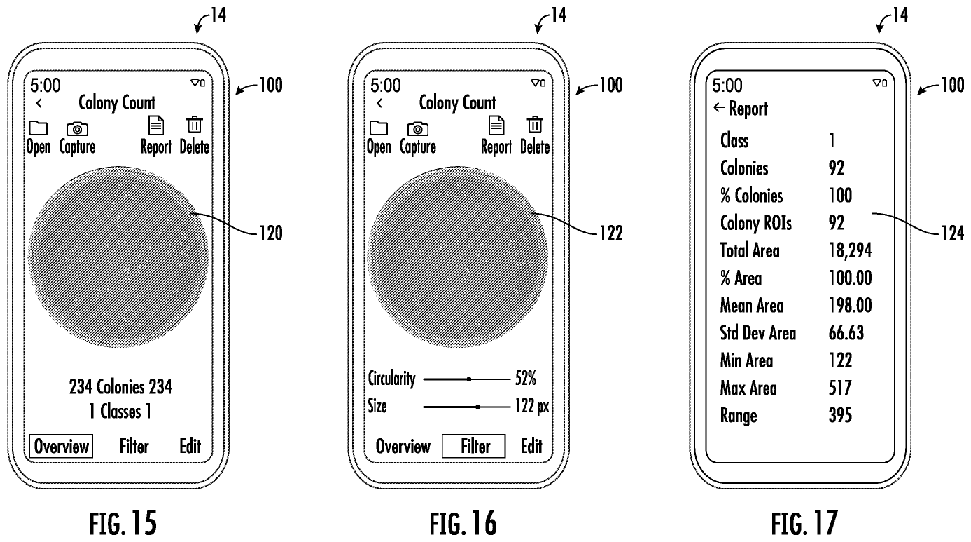

FIG. 14 depicts an exemplary screen 118 of the graphical user interface 100 illustrating a colony count, categorizing colonies by classes, according to the present disclosure. FIG. 15 depicts an exemplary screen 120 of the graphical user interface 100 illustrating a colony count, with automated colony detection, according to the present disclosure. FIG. 16 depicts an exemplary screen 122 of the graphical user interface 100 illustrating a colony count, filtering colonies by size and circularity, according to the present disclosure. FIG. 17 depicts an exemplary screen 124 of the graphical user interface 100 illustrating a report generated from the colony count.

The imaging system 10 disclosed herein includes a mobile device 14 for capturing images of a sample 60 and controlling environment conditions within the imaging box 12 using a Bluetooth connection with components of the imaging system 10. The images may be stored and analyzed within the mobile device 14 and/or a cloud-based computing system 16.

1. A mobile imaging system, comprising:
an imaging box, including:
an enclosure for blocking an interior of the imaging box from ambient light, wherein the imaging box includes an opening through the enclosure;
a designated surface positioned within the interior of the imaging box for supporting a sample, wherein the sample, when supported on the designated surface, is viewable through the opening;
an energy source for transmitting light through the sample; and
a support structure fixedly attached to an exterior of the imaging box at the opening for releasably attaching a mobile device to the imaging box over the opening;
wherein, when the mobile device is releasably attached to the imaging box, the support structure is configured to face a camera lens of the mobile device toward the sample.

2. The mobile imaging system of claim 1, wherein the support structure includes a pair of fold latch mechanisms positioned on opposing sides of the opening of the imaging box.

3. The mobile imaging system of claim 2, wherein each of the pair of fold latch mechanisms includes a secured configuration in which the fold latch mechanism biases the mobile device toward the imaging box and a released configuration in which the fold latch mechanism is urged against the bias away from the mobile device.

4. The mobile imaging system of claim 2, wherein the imaging box includes an electronic control system controlling at least one electronically controlled component of the imaging box.

5. The mobile imaging system of claim 4, wherein the at least one electronically controlled component of the imaging box is a controller for an environmental condition inside the imaging box.

6. A mobile imaging system facilitating communication between an imaging box electronic control system and a mobile device, comprising:
an imaging box, including:
an enclosure for blocking an interior of the imaging box from ambient light, wherein the imaging box includes an opening through the enclosure;
a designated surface positioned within the interior of the imaging box for supporting a sample, wherein the sample, when supported on the designated surface, is viewable through the opening;
an energy source for transmitting light through the sample; and
a support structure fixedly attached to an exterior of the imaging box at the opening for releasably attaching a mobile device to the imaging box over the opening;
wherein, when the mobile device is releasably attached to the imaging box, the support structure is configured to face a camera lens of the mobile device toward the sample; and
the imaging box electronic control system controlling at least one electronically controlled component of the imaging box; and
a mobile app configured for installation on the mobile device and being configured to communicatively connect the mobile device and the imaging box electronic control system.

7. The mobile imaging system of claim 6, wherein the mobile app is configured for user interaction via a graphical user interface of the mobile device.

8. The mobile imaging system of claim 7, wherein the graphical user interface facilitates control of camera features of the mobile device including at least one of light, filter and lens.

9. The mobile imaging system of claim 6, wherein the support structure includes a pair of fold latch mechanisms positioned on opposing sides of the opening of the imaging box.

10. The mobile imaging system of claim 9, wherein each of the pair of fold latch mechanisms includes a secured configuration in which the fold latch mechanism biases the mobile device toward the imaging box and a released configuration in which the fold latch mechanism is urged against the bias away from the mobile device.

11. The mobile imaging system of claim 6, wherein the mobile app includes an imaging module for the mobile device configured for capturing photos using a camera of the mobile device.

12. The mobile imaging system of claim 11, wherein the mobile app includes an analysis module for the mobile device configured for analyzing the sample based on the photos.

13. The mobile imaging system of claim 6, wherein the mobile app is a cloud-based mobile app.
